(19) United States
(12) Patent Application Publication
(10) Pub. No.: US 2010/0157168 A1
(43) Pub. Date: Jun. 24, 2010

(54) Multiple, Independent User Interfaces for an Audio/Video Device

(76) Inventors: Randy R. Dunton, Phoenix, AZ (US); Tanner Woodford, Tempe, AZ (US)

Correspondence Address: TROP, PRUNER & HU, P.C., 1616 S. VOSS RD., SUITE 750, HOUSTON, TX, 77057-2631, US

(21) Appl. No.: 12/342,358

(22) Filed: Dec. 23, 2008

(51) Int. Cl. H04N 5/445; H04H 40/00

(52) U.S. Cl. 348/734; 455/3.06

(57) ABSTRACT

An audio/video device may be part of or coupled to a video display, such as a television. The audio/video device may sync up with dedicated remote controls and remote controls, such as cellular telephones, that are not dedicated to the audio/video device. As a result, multiple independent displays may be provided, including a first display on said video display that may, for example, be a television program and a second display on each of one or more remote controls. The remote controls may display desired information independent of other remote controls and independent of the video display. For example, the remote controls may display an electronic programming guide, while the video display displays a television program.

### BACKGROUND

This relates generally to audio/video devices such as televisions.

Traditionally, televisions may be operated by a remote control. One user at a time can control what is displayed on the television, be it a television program or an electronic programming guide. Thus, generally one user controls what is displayed on the screen at any time.

### BRIEF DESCRIPTION OF THE DRAWINGS

FIG. 1 is a schematic depiction of one embodiment of the present invention;

FIGS. 2-7 show user interfaces in connection with one embodiment of the present invention;

FIG. 8 is a flow chart for one embodiment; and

FIG. 9 is a schematic depiction of another embodiment.

### DETAILED DESCRIPTION

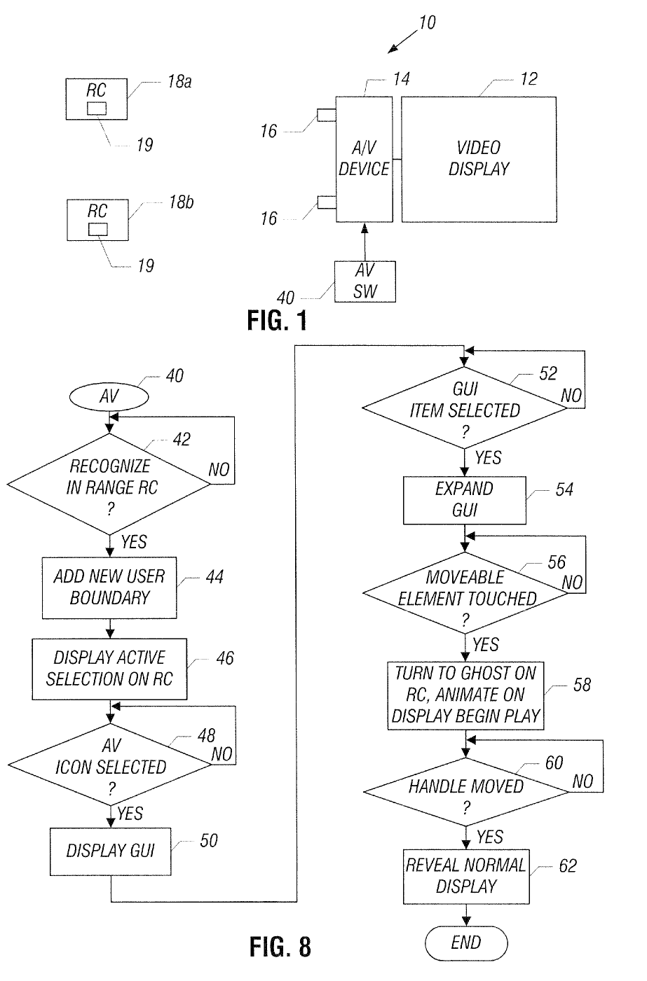

Referring to FIG. 1, an audio/video display device 12, such as a television or other video display, may be controlled by an audio/video device 14, such as a connected audio/video device. A connected audio/video (CAV) device 14 is coupled to the Internet. The audio/video device 14 provides an interface to the device 12 and may be internal to the device 12 or coupled to it wirelessly or by wires.

Various electronic devices may be networked together in such a way to provide a user with a means for entertainment via a connected media center device and a single display device. Each of these electronic devices typically receives, processes and/or stores content. Example electronic devices may include personal computers (PCs), televisions, digital video disk (DVD) players, video cassette recorder (VCR) players, compact disk (CD) players, set-top boxes (STBs), stereo receivers, audio/video receivers (AVRs), media centers, personal video recorders (PVRs), digital video recorders (DVRs), gaming devices, digital camcorders, digital cameras, cellular phones, personal digital assistants (PDAs), mobile Internet devices (MIDs), and so forth. The connected media device may also be adapted to receive content from multiple inputs representing Internet Protocol (IP) input connections, person-to-person (P2P) input connections, cable/satellite/broadcast input connections, Digital Video Broadcast, DVB-H and DMB-T transceiver connections, Advanced Television Standards Committee (ATSC) and cable television tuners, Universal Mobile Telecommunications Systems (UMTS) and Worldwide Interoperability for Microwave Access (WiMAX), Internet Protocol Television (IPTV) through Digital Subscriber Line (DSL) or Ethernet connections, (WiMax) and Wifi connections, Ethernet connections, and so forth.

The audio/video device 14 may include one or more wireless interfaces 16 to receive wireless commands from one (or more than one) remote control 18. The audio/video device 14 receives input commands and controls the display device 12 to selectively display a graphical user interface, an electronic programming guide, a television program, or other media. In one embodiment, the remote control is dedicated to a particular audio/video device 14. In other embodiments, the remote control is not dedicated to a particular audio/video device 14 and, in fact, may have other functions beyond remote control, such as wireless communications or telephone functions. In some embodiments, the audio/video device 14 is able to remote its graphical user interfaces for display on dedicated or non-dedicated remote controls 18.

In one embodiment, the remote control 18 may be a conventional television remote control except that it includes its own independent display 19. The display 19 may be a touch screen in some embodiments. The remote control 18 may also be a mobile Internet device (MID) in one embodiment. Examples of mobile Internet devices include cellular telephones, conventional remote controls, and personal digital assistants. In some cases, more than one remote control 18 may be used. In such case, each remote control 18a, 18b may be used to independently control the audio/video device 14.

The remote control 18 may be any mobile or personal device capable of communicating user commands to an audio/video device 14 and displaying graphical user interfaces. The remote control 18 may be implemented as part of a wired communication system, a wireless communication system, an infra-red system, or a combination thereof. In one embodiment, for example, the remote control 18 may be implemented as a mobile computing device having wireless or infra-red capabilities. A mobile computing device may refer to any device which can be easily moved from place to place. In embodiments, the mobile computing device may include a processing system. The remote control 18 may be a mobile Internet device (MID), a television remote control, smart phone, handheld computer, palmtop computer, personal digital assistant (PDA), cellular telephone, combination cellular telephone/PDA, pager, one-way pager, two-way pager, messaging device, data communication device, MP3 player, laptop, ultra-mobile PC, smart universal remote control, and so forth.

In embodiments, the remote control 18 may represent a device that includes user input features or interaction options such as, but not limited to, a microphone, touch screen, gyroscope, keyboard, biometric data readers, screen size, types of media or content information stored and/or supported, and so forth. One or more of the interaction options may include haptic technology. In general, haptic technology refers to technology which interfaces to the user via the sense of touch by applying forces, vibrations and/or motions to the user.

Each remote control 18 may include a display 19 and a wireless interface that provides wireless communications with a variety of devices, including the audio/video device 14. These communications may be infrared communication and/or short range radio frequency communication, such as Bluetooth® radio frequency communications, to mention two examples.

In some embodiments, each user of a remote control 18a or 18b can independently control what is displayed on the display device 12 because each may independently interact with the audio/video device 14. This allows one person to view a graphical user interface, such as an electronic programming guide, on a remote control 18, while the other user is displaying video, such as a television program, on the display device 12 under control of a different remote control. Ultimately, only one user can control what is actually displayed on the display device 12, but providing multiple independent access to the graphical user interfaces, such as an electronic programming guide, enables another user to see if there is something that perhaps both users might prefer to display on the larger display of the display device 12.

In some embodiments, the content displayed on the display device 12 may be any type of content or data. Examples of content may generally include any data or signals representing information meant for a user, such as media information, voice information, video information, audio information, image information, textual information, numerical information, alphanumeric symbols, graphics, and so forth. Although embodiments of the invention are described herein as being applicable to home entertainment or media related environments, this is not meant to limit the invention. In fact, embodiments of the invention are applicable to many environments including, but not limited to, office environments, healthcare environments, educational environments, research environments, and so forth. The embodiments are not limited in this context.

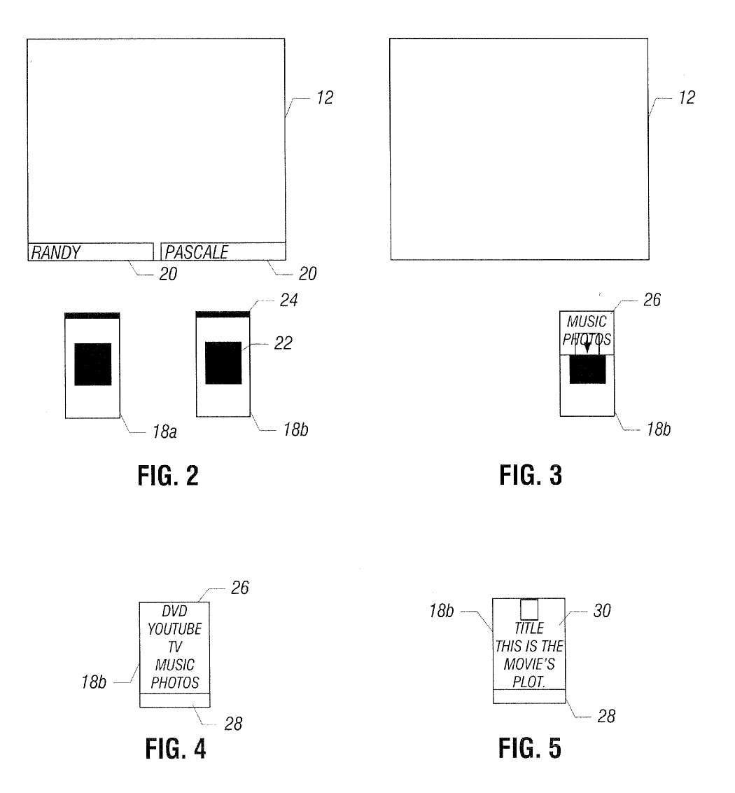

Thus, in accordance with one embodiment, the display device 12 may display a banner at the bottom of its screen, indicating which users of remote controls have linked up with the audio/video device 14. In an example shown in FIG. 2, the bottom banner 20 of the display device 12 screen is split into regions labeled with the names, Randy and Pascale, of users of registered remote control devices. This indicates these users that have registered with the audio/video device 14. Each user's remote control 18a or 18b display screen may include an icon 24 at the top and a touch pad area 22, indicated in the middle, in one embodiment. The touch pad area 22, in one embodiment, allows remote control of a cursor on the screen 12.

Referring next to FIG. 3, Pascale, using remote control 18b, may want to try to see what else is available for viewing in this television based example. To do this, Pascale may simply touch the icon 24 and drag it towards the bottom of the display in one embodiment. A graphical user interface 26 unfolds, unravels, opens up, or slides down to fill the display screen in one embodiment. The handle 28 is provided so that the interface 26 can be closed, as shown in FIG. 4.

Then, as shown in FIG. 5, the user of the remote control 18b can select one of several user selectable icons in the graphical user interface 26 in this embodiment. In this case, the option DVD was selected and the title of a movie and the movie's plot is displayed at 30 on the device 18b, as shown in FIG. 5. Note the handle 28 at the bottom of the display to indicate that the display can effectively be closed or moved upwardly to reveal the underlying material that was covered up by the seemingly overlying display in FIG. 3.

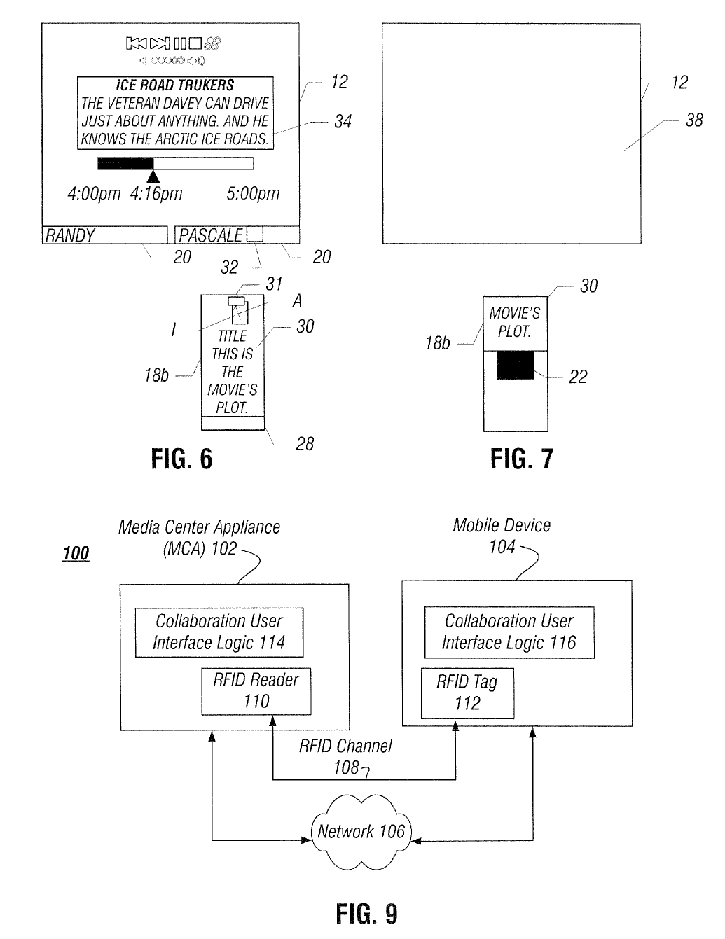

Referring next to FIG. 6, the two users of one or more remote controls 18b agree to switch the display device 12 to show the DVD movie that Pascale found. Pascale can use a remote control to drag (as indicated by arrow A) the movie poster icon I (which represents the media item: DVD) on the remote control display from the earlier search over the upper boundary 31 of her local remote control display and it will appear to both viewers on screen 12, originating from Pascale's banner 20, also causing the display 12 to switch to being controlled by Pascale. The movie is now represented by the icon 32 in Pascale's banner 20.

Then, as shown in FIG. 7, Pascale moves the connected audio/video graphical user interface 30 up and off the display screen of the remote control 18b and her remote control becomes a free-form pointing device or touch pad 22. She can use the pointing device or touch pad 22 to launch the movie from it's icon 32 to a full screen movie, as indicated at 38. In one embodiment, this is a result of Pascale moving the graphical user interface 30 upwardly off the screen by activating (i.e. “lifting”) the handle 28, shown in FIG. 6.

In this way, each user has the ability to see what other audio/video entertainment options may be available, while a different user continues to view a previous selection.

Referring to FIG. 8, in one embodiment, the audio/video device 14 may be a processor-based system loaded with the connected audio/video software 40, as shown in FIG. 1. The connected audio/video software 40, detailed in FIG. 8, begins by recognizing an in-range remote control at diamond 42. When such a device is recognized, a new user banner 20 is displayed, as indicated in block 44, and as shown in FIG. 2. The act of recognition is clear to the viewer on the display screen 12 by the banner 20, and is also displayed on the newly connected remote control's screen as an icon 24, as indicated in block 46.

Next, a check at diamond 48 determines whether an icon has been selected on the newly connected remote control, as indicated in diamond 48. If so, a graphical user interface is displayed on the remote control display, as indicated in block 50 and as shown in FIG. 4.

If an option is selected on that graphical user interface, as determined in diamond 52, the graphical user interface is expanded to display information about the selection, as indicated in block 54 and as shown in FIG. 5.

Next, a check at diamond 56 determines whether a “moveable,” graphical element has been “touched.” If so, the display of the remote control turns to a ghost or faint image and the display is animated (block 58) to begin and play of the selection begins, as indicated in FIG. 5 at 30.

Thereafter, a check at diamond 60 determines whether the handle 20 has been moved. If it has been moved, the normal remote control touch pad display is revealed, as indicated in block 62, in that the material “underneath” the display is now exposed, as indicated at 36 in FIG. 7.

In some embodiments, the remote control 18 is further adapted to interact with an audio/video device 14 in such a way that when the two are within certain proximity of each other, the remote control 18 is able to act as a remote control for the audio/video device 14. The audio/video device 14 and remote control 18 may be adapted to include collaboration user interface logic and the ability to determine when the two are within certain proximity of each other. Once the audio/video device 14 and remote control 18 are connected (and within certain proximity), they exchange information that is used to develop a collaboration user interface between the two. For example, the audio/video device 14 may have a speech recognition application but no microphone for a user to enter voice data. The remote control 18 may have a microphone. In embodiments, the collaboration user interface allows the input features or interaction options or capabilities found on the mobile device to be used for one or more user interfaces or applications on the audio/video device 14. For example, the collaboration user interface facilitates the microphone on the mobile device to be used to enter voice data into the speech recognition application of the audio/video device 14.

A system 100, shown in FIG. 9, may comprise a media center appliance (MCA) 102, a mobile device 104, a network 106 and a radio frequency identification (RFID) channel 108. MCA 102 may be a form of audio/video device 14 of the embodiment of FIG. 1. MCA 102 may include a RFID reader 110 and collaboration user interface logic 114. Mobile device 104 may include a RFID tag 112 and collaboration user interface logic 116. Mobile device 104 may be an example of the remote control 18 of the embodiment of FIG. 1.

In embodiments, MCA 102 may be any connected device capable of performing the functionality of the invention described herein. Examples may include, but are not limited to, a connected high-definition television (HDTV), a connected advanced set-top box (STB), and so forth. MCA 102 may be owned, borrowed or licensed by its respective user.

In embodiments, MCA 102 is adapted to receive multiple inputs supporting different sources of media or content. The multiple inputs may represent various types of connections including wired, wireless, infra-red, or some combination thereof. More specifically, the multiple inputs may represent Internet Protocol (IP) input connections, a peer-to-peer (P2P) input connection, broadcast/satellite/cable input connections, DVD-H and DMB-T transceiver connections, ATSC and cable television tuners, UMTS and WiMAX, IPTV through DSL or Ethernet connections, WiMax and Wifi connections, Ethernet connections, and inputs from various electronic devices. Example electronic devices may include, but are not limited to, televisions, DVD players, VCR players, CD or music players, STEs, stereo receivers, AVRs, media centers, PVRs, DVRs, gaming devices, digital camcorders, digital cameras, blackberries, cellular phones, PDAs, laptops, flash devices, MIDs, ultra-mobile PCs, MP3 players, and so forth.

In embodiments, MCA 102 may represent a device that includes personal video recorder (PVR) functionality. PVR functionality records television data (i.e., requested content) in digital format (e.g., MPEG-1 or MPEG-2 formats) and stores the data in a hard drive or on a server, for example. The data may also be stored in a distributed manner such as on one or more connected devices throughout an environment. In embodiments, a PVR could be used as a container for all things recorded, digital or other (e.g., DVRs).

In embodiments, MCA 102 may represent a device that includes one or more applications. Example applications may include speech recognition applications, searching applications, graphical user interface (GUI) applications, user identification applications, and so forth.

In embodiments, when mobile device 104 is acting as a remote control for MCA 102 via the collaboration user interface, it may also act as a remote control for other devices in its environment. In embodiments, two or more mobile devices 104 may participate at once to create a collaboration user interface with MCA 102. For example, if a second mobile device were to be within certain proximity with MCA 102, two people can interact collaboratively with the same MCA 102.

Network 106 of FIG. 9 facilitates communication between MCA 102 and mobile device 104. Network 106 may be a local area network (LAN), high speed Internet network, or any other type of network suited for the particular application. Network 106 may be wireless, infra-red, wired, or some combination thereof. Other types of networks may be added or substituted as new networks are developed.

RFID channel 108 allows for communication between RFID tag 112 in mobile device 104 and RFID reader 110 in MCA 102. RFID technology allows for the means to determine the rough proximity between MCA 102 and mobile device 104. RFID technology also facilitates MCA 102 to uniquely identify mobile device 104. Embodiments of the invention are not limited to RFID technology and contemplate the use of any technology that allows for the determination of the rough proximity and/or identification between two or more devices including, for example, Bluetooth® technology.

In embodiments, once mobile device 104 is uniquely identified by MCA 102 (via, for example, RFID technology), MCA 102 and device 104 exchange user interface capability information with each other. In other embodiments, only device 104 sends user interface capability information to MCA 102. For example, MCA 102 may provide device 104 with the various applications it supports, the types of media or content information stored and/or supported, etc. As described above, example applications may include speech recognition applications, searching applications, graphical user interface (GUI) applications, identification applications, and so forth. In exchange, device 104 may provide MCA 102 with the various input features or interaction options it includes that might be useful to a user interface for MCA 102. As mentioned above, such interaction options may include a microphone, touch screen, gyroscope, keyboard, biometric data readers, screen size, types of media or content information stored and/or supported, etc. In embodiments, this information is exchanged via network 106.

In embodiments, collaboration user interface logic 114 of MCA 102 uses the provided interaction options of device 104 to create a MCA application or widget that includes counterpart user interface components for a collaboration user interface. The counterpart user interface components may include mobile device user interface components and MCA user interface components. The collaborative user interface is one between MCA 102 and mobile device 104.

In embodiments, MCA 102 transfers the MCA application or widget with the mobile device counterpart user interface components to mobile device 104 via collaboration user interface logic 116. Once downloaded to mobile device 104, the MCA application or widget appears as an icon (such as icon 24 in FIG. 2) on the mobile device user interface when the two are within a certain proximity to each other. Similarly, a mobile device icon (such as banner 20) may be displayed on the user interface of MCA 102 to indicate to a user that the two are connected and facilitate a collaboration user interface. In embodiments, when the MCA icon is activated, mobile device 104 acts as a remote control device for MCA 102 by having the mobile device user interface components interact with their counterpart MCA user interface components.

The ability of the MCA 102 to communicate with a mobile device 104 may be established during a set up sequence. In some embodiments, it is implemented automatically when the MCA 102 comes into sufficient proximity to a mobile device 104 to establish a wireless communication link. In some embodiments, using conventional technology, the wireless communication link is automatically established. Upon establishment of the wireless communication link, information may be exchanged between the mobile device 104 and the MCA 102 about the characteristics of each device. This may allow, in some embodiments, the MCA 102 to select a software script package to transfer to the mobile device 104 to facilitate communications between the two. Once these communications have been established, the mobile device 104 may be recognized by the MCA 102. Such recognition may include recognizing the identity of the mobile device 104 and thereby identifying it through the user's name, as suggested in the example given above or, otherwise, separating commands received from one mobile device 104 from those received from other mobile devices 104.

In embodiments in which a mobile device 104 is used to display an electronic programming guide, it may be the case that the display screen that is available for the electronic programming guide is relatively small and, therefore, the electronic programming guide must be displayed in compact format. This may be done in any way, including organizing the information to show the information in categories, such as what is currently being displayed by alphabetization, by channel, or by favorites. Thus, by displaying categories of information in a better organized fashion, the information that the user needs the most may be provided in a compact format. In addition, software lensing may be utilized where the user is provided with the ability to zoom in on what the user wants to see. Thus, the basic information may be provided in a relatively brief or small format and by use of software lensing, more information may be provided. One form of software lensing is the use of a looking glass feature which allows the user to zoom in on features about which the user wants more information. Another software lensing technology allows the user to touch a display and spread the user's fingers to expand that portion of the display.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling an audio/video device to simultaneously display content on a video display and a graphical user interface associated with said video display on a remote display.

2. The method of claim 1 including enabling access to a graphical user interface on said remote display while a television program is being displayed on said video display.

3. The method of claim 1 including remoting a graphical user interface from said audio/video device to a remote control for said video display.

4. The method of claim 3 including enabling a mobile device, not dedicated to the audio/video device, to register with said audio/video device for controlling said audio/video device and to receive a graphical user interface from said audio/video device for display on said mobile device.

5. The method of claim 1 including enabling a mobile Internet device to receive a graphical user interface from said audio/video device.

6. The method of claim 1 including enabling a remote control to automatically synchronize with said audio/video device to enable said audio/video device to be controlled by said remote control and to enable said audio/video device to remote graphical user interfaces for display on a display on said remote control.

7. The method of claim 6 including enabling said remote control to automatically synchronize with said audio/video device in response to proximity to said audio/video device.

8. The method of claim 7 including enabling a cellular telephone to act as said remote control.

9. The method of claim 8 including enabling multiple cellular telephones to independently control said audio/video device.

10. The method of claim 9 including enabling said cellular telephones to display a graphical user interface with what appears to be a lower display being a touch pad application, and what appears to be an overlying display includes a graphical user interface to control said video display.

11. An apparatus comprising:
a wireless interface;
a connection to a video display; and
a control to control the image displayed on said video display and to remote a graphical user interface associated with said video display for display on a remote control.

12. The apparatus of claim 11 wherein said video display is a television receiver.

13. The apparatus of claim 12 wherein said remote control is a dedicated remote control for said television receiver.

14. The apparatus of claim 12 wherein said remote control is a cellular telephone.

15. The apparatus of claim 14 wherein said control to automatically synchronize with said cellular telephone when said cellular telephone is proximate to said control.

16. The apparatus of claim 12 wherein said graphical user interface is an electronic programming guide.

17. The apparatus of claim 11, said control to synchronize with a remote control that is not dedicated for use with said control.

18. The apparatus of claim 11, said control to produce a pair of overlapping displays on said remote control, one of said displays to control a remote video display and the other of said displays being a graphical user interface, an overlying display appearing to be slidable to slide off of an underlying display.

19. The apparatus of claim 11, said control to be controlled by multiple remote controls, each remote control to separately display graphical user interface information independently of at least one other remote control.

20. The apparatus of claim 11 including a connected audio/video device, said control being part of said connected audio/video device.
